(19) United States
(12) Patent Application Publication
(10) Pub. No.: US 2026/0271116 A1
(43) Pub. Date: Sep. 10, 2026

(54) AUTOMATED RECONNECTION OF A DROPPED CALL

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 19/447,255

(22) Filed: Jan. 13, 2026

Related U.S. Application Data
(60) Provisional application No. 63/766,523, filed on Mar. 4, 2025.

(51) Int. Cl. H04W 76/19

(52) U.S. Cl. CPC H04W 76/19

(57) ABSTRACT

A system and method for automated reconnection of a dropped call. When a dropped call is detected, a first device may maintain a user interface of the first call and operate in one of reconnect initiator or responder mode. When in reconnect initiator mode, the first device may initiate a second call with the second device. When in reconnect responder mode, the first device may listen for the second call from the second device. The first device may automatically answer the second call and merge the first and second calls. In other examples, a call server may detect the dropped first call and operate in one of reconnect initiator or responder mode to reconnect the devices via a second call. Detecting a dropped call may be based on one or more factors. One factor may be whether a device is in or near a user-or automatically-defined call drop zone.

### CROSS-REFERENCE TO RELATED APPLICATIONS

This application claims the benefit of U.S. Provisional Application No. 63/766,523 filed Mar. 4, 2025, entitled, “Automated Reconnection of a Dropped Call,” which is incorporated herein by reference in its entirety. To the extent appropriate a claim of priority is made to the above-disclosed application.

### BACKGROUND

Calls may be established between a first device and a second device connected via a communications network. In today's interconnected world, reliable communication is expected. However, there are instances when calls are unexpectedly dropped due to issues such as signal failures. These disruptions can occur at inconvenient times, causing frustration and inconvenience. It is with these observations in mind, among others, that aspects of the present disclosure were conceived.

### SUMMARY

The present disclosure describes a system and method for providing automated reconnection of a dropped call. A reconnection functionality may be provided to detect a dropped call and activate one of reconnect initiator mode or reconnect responder mode. When operating in reconnect initiator mode, a second call may be initiated. Operating in reconnect responder mode may include listening for the second call and automatically answering the second call when received. Additionally, the first call and second call may be merged to reconnect communication between the first device and the second device.

One aspect of the present disclosure includes a method that may be performed by a first device, comprising: engaging in a first call with a second device including causing a user interface for the first call to be displayed; maintaining, after detecting a drop of the first call, the user interface for the first call; activating one of a reconnect initiator mode or a reconnect responder mode; when operating in the reconnect initiator mode: initiating a second call with the second device; and engaging in the second call with the second device when the second call is answered by the second device; and when operating in the reconnect responder mode: listening for the second call from the second device; automatically answering the second call when the second call from the second device is received; and engaging in the second call with the second device.

Another aspect of the present disclosure includes a system of a first device comprising: at least one processing unit; and memory storing instructions that, when executed by the at least one processing unit, cause the system to perform operations comprising: engaging in a first call with a second device including causing a user interface for the first call to be displayed; maintaining, after detecting a drop of the first call, the user interface for the first call; activating one of a reconnect initiator mode or a reconnect responder mode; when operating in the reconnect initiator mode: initiating a second call with the second device; and engaging in the second call with the second device when the second call is answered by the second device; or when operating in the reconnect responder mode: listening for the second call from the second device; automatically answering the second call when the second call from the second device is received; and engaging in the second call with the second device.

Another aspect of the present disclosure includes a method that may be performed by a call server, comprising: detecting a drop of a first device from a first call facilitated by the call server between the first device and a second device; activating one of a reconnect initiator mode or a reconnect responder mode; when operating in the reconnect initiator mode: maintaining the first call with the second device by becoming a temporary endpoint of the first call; initiating a second call from the call server to the first device; and merging the first call with the second call when the second call is answered by the first device; or when operating in the reconnect responder mode: maintaining the first call with the second device; listening for the second call from the first device; routing the second call to the second device when the second call from the second device is received; and merging the first call with the second call when the second call is answered by the second device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a diagram of an example system in which automated dropped call reconnection may be implemented according to an example.

FIG. 2A shows an example user notification that may be provided during a reconnection attempt according to an example.

FIG. 2B shows another example user notification that may be provided during a reconnection attempt according to an example.

FIG. 2C shows an example user notification that may be provided when a reconnection attempt fails according to an example.

FIG. 3 is a flowchart illustrating operations of a method for providing automated dropped call reconnection according to an example.

FIG. 4 is a flowchart illustrating operations of a method for providing automated dropped call reconnection according to another example.

FIG. 5 is a flowchart illustrating operations of a method for providing automated dropped call reconnection according to another example.

FIG. 6 is a block diagram of a computing device with which one or more aspects of the disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As noted above, reliable communication in today's world is expected. However, there are instances when calls may be unexpectedly dropped due to issues such as signal failures. In some cases, dropped calls can pose significant risks in emergency situations, where communication may be essential for safety. In other cases, one or both of the call participants may try to recall the other, which may present additional frustration and inconvenience. Thus, a system and method are provided for automated reconnection of a dropped call. The automated reconnection may provide a seamless interface by keeping state of the dropped call and merging the dropped call with a subsequent call, thus minimizing the negative impact of the unintended disconnection.

In some examples, a dropped first call is detected by a device participating in the first call and a reconnection attempt is initiated by the device. The device may operate in one of reconnect initiator mode or reconnect responder mode. When operating in reconnect initiator mode, the device may maintain a user interface of the first call and initiate a second call with the other device. When operating in reconnect responder mode, the device may maintain the user interface of the first call and listen for the second call from the other device. When the second call from the other device is received, the device may automatically answer the second call and merge the first and second calls.

In other examples, a network call server may detect a drop of a first device from a first call with a second device. The call server may operate in one of reconnect initiator mode or reconnect responder mode. When operating in reconnect initiator mode, the call server may maintain the first call with the second device and initiate a second call with the first device. When the second call is answered by the first device, the call server may merge the first call and the second call. When operating in reconnect responder mode, the call server may maintain the first call with the second device and listen for the second call from the first device. When the second call from the first device is received, the call server may route the second call to the second device and merge the first and second calls when the second call is answered by the second device.

Detecting a dropped call may be based on one or more factors. One factor may include a determination of whether a device is in or near a call drop zone. In some examples, the call drop zone is defined by a user. For instance, the user may define the call drop zone based on a location where a number of dropped calls have been experienced. In other examples, the call drop zone is automatically defined. For instance, a location where a threshold number of dropped calls are detected may be automatically defined and stored as a call drop zone. The call drop zone may be device specific or may be defined based on dropped calls experienced by a plurality of devices.

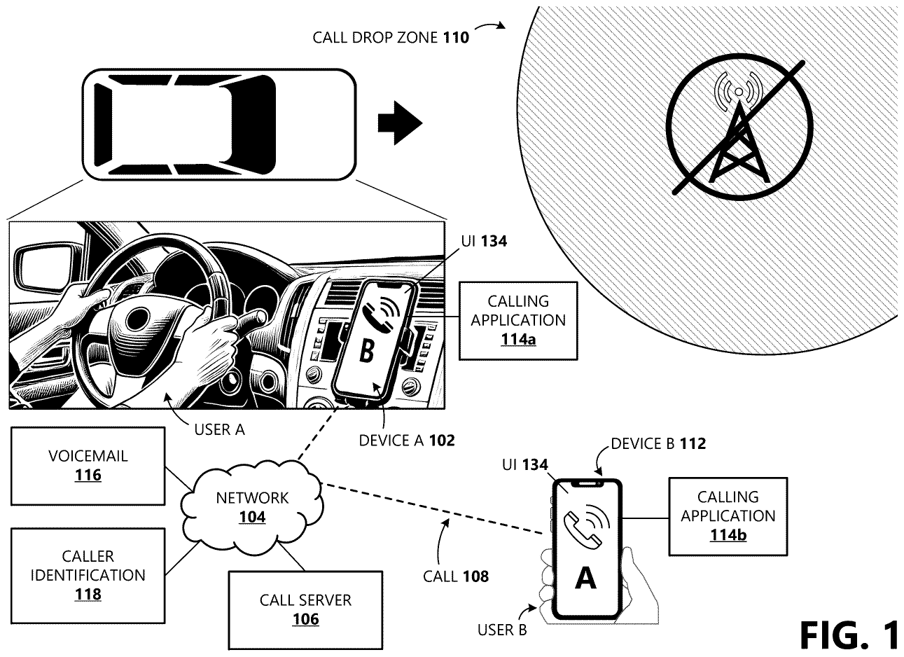

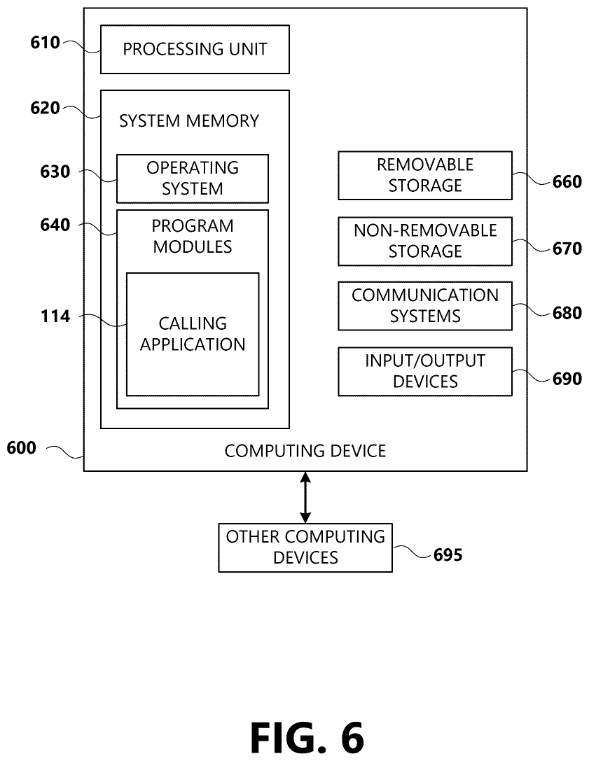

FIG. 1 depicts an example system 100 in which automated reconnection of a dropped call may be implemented based on aspects of the present disclosure. In examples, the system 100 includes communication devices (a first device 102 and a second device 112), which may include various types of electronic devices configured to communicate via a network 104 (e.g., mobile phones, tablet computers, desktop computers, gaming devices, wearable devices, etc.). A first user (user A) may utilize the first device 102 and a second user (user B) may utilize the second device 112. In examples, each device 102 and 112 may include a processor configured to execute a plurality of applications of the device 102 and 112. The applications may include a calling application 114a and 114b (collectively, calling application 114) that enables the device 102 and 112 on which it is operating to perform a call functionality, such as engaging in a call 108 with the other device or another device. Calls 108 may include Public Switched Telephone Network (PSTN) calls, Voice over Internet Protocol (VoIP) calls, Voice over Long-Term Evolution (VoLTE) calls, or other types of calls based on the devices 102 and 112 and network 104 implemented. The calling application 114 may be implemented as a standalone application, a web browser, an integrated feature of a software platform, etc. The devices 102 and 112 may include additional components, such as memory, an antenna, input devices and/or output devices, a battery, etc. For example, devices 102 and 112 may comprise computing devices 600 as described in relation to FIG. 6.

Each device 102 and 112 may be configured to communicate with one or more networks 104, such as a cellular network (e.g., LTE network), an IP network, a traditional circuit-switched network (e.g., PSTN or Integrated Services Digital Network (ISDN)), etc. In examples, the devices 102 and 112 may establish a connection with the network 104 to perform calls 108 with other devices. For example, the call 108 may be performed using circuit switching when the first device 102 or the second device 112 is connected to a circuit-switched network, VoIP when the first device 102 or the second device 112 is connected to an IP network, VoLTE when the network 104 is an LTE network, etc. The network 104 may include various numbers of components (e.g., servers, switches, routers, etc.) to manage calls 108 and other communication traffic. When a call 108 is performed, a setup process may be performed between the devices 102 and 112 based on one or more communication protocols to establish a communication link for transmitting media (e.g., voice data), such as Session Initiated Protocol (SIP), Real-Time Transport Protocol (RTP), ISDN, and/or other protocols. The call 108 may be established based on a successful transmission of various signaling messages. In some examples, the communication link may include a dedicated bearer established to connect each device 102 and 112 to the network 104 for transmitting media data between devices 102 and 112.

The system 100 further includes at least one call server 106, such as an SIP server, a Private Branch Exchange (PBX), a communication server, an application server, or another type of network component responsible for managing signaling and routing of calls 108 in the network 104. The call server 106 may be part of an infrastructure that a service provider uses to perform tasks related to establishing, managing, and terminating call sessions (calls 108) between the devices 102 and 112. In some examples, the call server 106 routes calls 108 through a service provider network and connects calls 108 to an intended destination, which may include routing calls to other networks 104. In some examples, the call server 106 further facilitates the delivery of media data between devices 102 and 112. The call server 106 may include or access subscription information for a user of the first device 102 and/or the second device 112. For instance, the subscription information may be used to authenticate users and enable telephony services. The call server 106 may further provide features, such as voicemail 116, caller identification 118, call waiting, call forwarding, conference calling, and/or other telephony services.

In some cases, during a call 108, one of the devices 102 or 112 may experience an unintentional drop from the network 104 and the call 108 may fail. The unintentional disconnection may be due to being in a call drop zone 110 (e.g., where the device 102 or 112 cannot receive a signal from the network 104 or where the signal is not strong enough to maintain the call 108), network issues, or device problems. Consider, for instance, the first device 102 loses its signal and drops from a first call 108 between the first device 102 and the second device 112. In examples, the first device 102 may not be able to communicate with the network 104 until it is moved out of the call drop zone 110 or otherwise re-establishes a connection to a cell tower or access point and can communicate with the network 104.

In some implementations, a reconnect functionality is provided by the calling application 114 to automatically reconnect a first device 102 and a second device 112 via a second call 108 when a dropped call is detected. For instance, the reconnect functionality may allow the calling application 114 to perform an automated reconnection attempt with the other device 102 or 112. In some examples, performing the reconnection attempt may cause the calling application 114a operating on the first device 102 to operate in “reconnect initiator mode” and the calling application 114b on the second device 112 to operate in “reconnect responder mode”. The calling applications 114a and 114b may be configured to determine which mode (e.g., reconnect initiator mode or reconnect responder mode) to activate on a device 102 or 112 based on which device dropped the first call 108, which device initiated the first call 108, or another predetermined factor. In examples, a particular mode may be activated on the device that dropped the first call 108 when the device regains a connection to the network 104.

When operating in reconnect initiator mode, the calling application 114a may be configured to maintain state of the first call 108. For instance, the calling application 114a may retain context of the first call 108. Context of the first call 108 may include information about the other call participant (e.g., phone number, IP address, and/or other unique resource identifier of the second device 112), session parameters, media path details, etc. For instance, context of the first call 108 may be temporarily retained by the calling application 114a and, in some examples, used to initiate the second call 108 with the second device 112. In some examples, one or more call setup steps of the second call 108 may be eliminated based on using the retained context of the first call 108. For instance, parameters such as codec selection, Quality of Service (QoS) settings, and/or other session-related configurations (e.g., encryption settings, network preferences, and/or user-specific settings) established during the first call 108 may be reused for the second call 108 and, thus, may avoid renegotiating the parameters with the second device 112. In some examples, resources allocated during the first call 108, such as network bandwidth, processing power, and memory, may be maintained and reused for the second call 108. This may avoid additional computing required to reallocate resources and provide a smooth transition between the first call 108 and the second call 108.

In some examples, initiating the second call 108 includes inviting the second device 112 to join a communication session. Additionally, one or more parameters may be applied to the second call 108, such as a time-out parameter for voicemail. For instance, the time-out parameter may trigger a termination of the second call 108 to prevent the second call 108 from being forwarded to voicemail 116 if the second call 108 is not answered by the second device 112. The time-out parameter for voicemail may be set to trigger after a certain number of rings or a specific duration so that the second call 108 is terminated instead of being sent to voicemail 116. In some examples, another parameter that may be applied to the second call 108 is a time-out parameter for reconnection attempts. For instance, the time-out parameter for reconnection attempts may deactivate/end reconnect initiator mode if the second call 108 is not answered after a maximum number of reconnection attempts.

When operating in reconnect initiator mode, the calling application 114a may be further configured to maintain a user interface (UI) 134 of the calling application 114a. In some examples, regardless of whether the first call 108 is dropped by the first device 102 or the second device 112, the calling application UI 134 on the first device 102 may remain open and active. In some examples, the calling application 114a may further provide a first user notification that indicates a connection issue with the second device 112 and/or the reconnection attempt. The first user notification may include one or a combination of a visual alert, an audible, or a tactile alert.

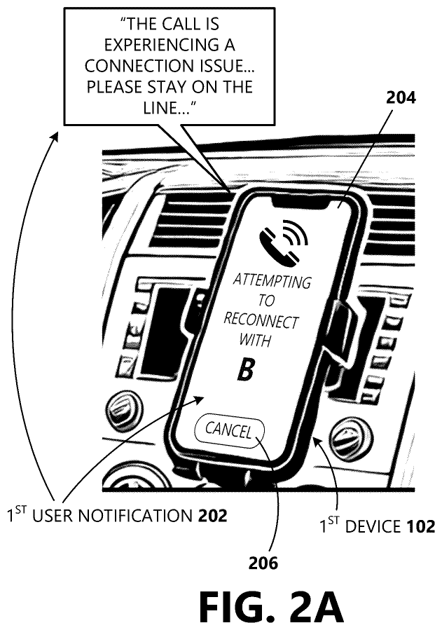

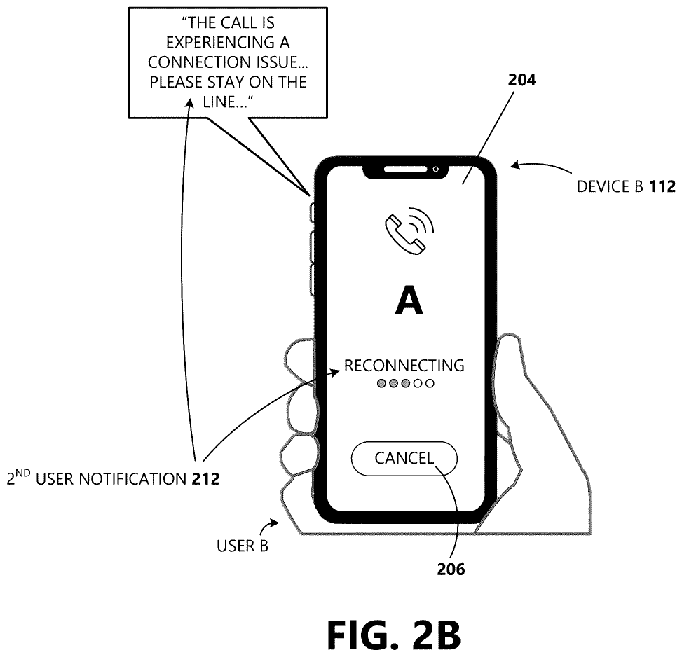

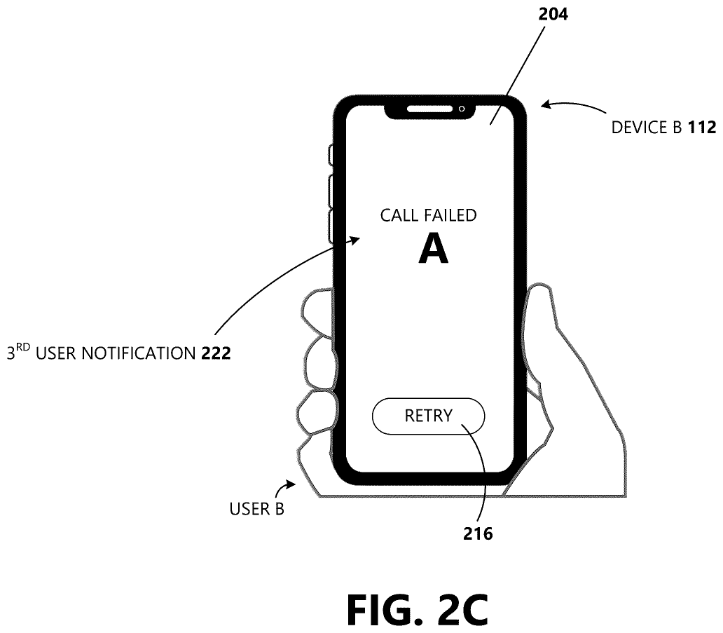

With reference to FIG. 2A, one example of the first user notification 202 is depicted. As shown, in some examples, the first user notification 202 may be displayed on a screen 204 integrated or connected to the first device 102. In other examples, the first user notification 202 may be provided as a sound (e.g., a tone or white noise), an announcement (e.g., a spoken message), or other audible indicator of a connection issue and/or reconnection attempt with the second device 112. In some examples, a cancel option 206 may be provided that allows user A to selectively cancel the reconnection attempt with the second device 112. For instance, when the cancel option 206 is selected by user A, reconnect initiator mode may be deactivated, and the second call attempt may be terminated. In further examples, when the cancel option 206 is selected, a message may be sent to the second device 112 to cancel or deactivate reconnect responder mode.

When operating in reconnect responder mode, the calling application 114b operating on the second device 112 may be configured to listen for the second call 108 from the first device 102 and to automatically answer the second call 108 when received. In some examples, the calling application 114b is configured to maintain state and retain context of the first call 108. For instance, when reconnect responder mode is activated, the calling application 114b may be configured to maintain state by keeping the calling application UI 134 open and active regardless of whether the first call 108 is dropped by the first device 102 or the second device 112. In some examples, the calling application 114a may further provide a second user notification that indicates a connection issue with the second device 112 and/or the reconnection attempt. The second user notification may include one or a combination of a visual alert, an audible, or a tactile or haptic alert.

With reference to FIG. 2B, one example of the second user notification 212 is depicted. As shown, in some examples, the second user notification 212 may include a visual alert displayed on a screen 204 integrated or connected to the second device 112. In other examples, the second user notification 212 may be provided as a sound (e.g., a tone or white noise), an announcement (e.g., a spoken message), or other audible alert of a connection issue and/or reconnection attempt with the first device 102. In some examples, a cancel option 206 may be provided that allows user B to selectively cancel the reconnection attempt with the first device 102. For instance, when the cancel option 206 is selected by user B, reconnect responder mode may be deactivated, and listening for the second call attempt from the first device 102 may be terminated. In further examples, when the cancel option 206 is selected, a message may be sent to the first device 102 to cancel or deactivate reconnect initiator mode.

When operating in reconnect responder mode, the calling application 114b may be further configured to temporarily retain context of the first call 108. In examples, when an incoming call 108 is received, the calling application 114b may compare the retained context with information about the calling device of the incoming call 108 (e.g., a phone number, IP address, or SIP address). The information about the calling device may be included in signaling data, a request or invitation to establish the incoming call 108, and/or provided by the caller identification 118. For instance, the calling application 114b may determine whether the calling device of the incoming call 108 matches identifier information of the first device 102 included in the retained context of the first call 108. When the calling device of the incoming call 108 is determined to be the first device 102, the calling application 114b identifies the incoming call 108 as the second call 108 from the first device 102 and, thus, a signal to reconnect. In examples, the calling application 114b may be configured to automatically answer the second call 108 and re-establish a second communication link over the network 104. In some examples, the calling application 114a may automatically answer the incoming second call 108 and connect to the second device 112 without announcing the incoming second call 108 to user B. For instance, the second device 112 may not emit a ringtone and/or provide an option to answer or decline the incoming call 108 when the incoming call 108 is received. In other examples, the incoming second call 108 may be announced and an option to answer or decline the incoming call 108 may be provided. In some examples, the UI 134 of calling application 114b may be updated to indicate the reconnection with the first device 102. Additionally, the UI 134 of calling application 114a operating on the first device 102 may be updated to indicate the reconnection with the second device 112.

In some examples, when the calling device of an incoming call 108 is determined to not be the second device 112 when operating in reconnect responder mode, the calling application 114b may be configured to not answer the incoming call 108. For instance, the incoming call 108 may be declined, forwarded to voicemail 116, or handled using a call waiting feature or other call management option. In some examples, an indication of the incoming call 108 is not provided. In other examples, an indication of the incoming call 108 is provided. The indication of the incoming call 108 may include an option that allows user B to select to decline the incoming call 108, end the reconnection attempt and answer the incoming call 108, hold the reconnection attempt and answer the incoming call 108, respond with a message to the calling device of the incoming call 108, send the incoming call 108 to voicemail 116, etc.

In some examples, one or more parameters may be applied when reconnect responder mode is activated and the calling application 114b is listening for the second call 108 from the first device 112. For instance, a time-out parameter may be applied that triggers a termination of reconnect responder mode if the second call 108 from the first device 112 is not received within a threshold time period. In some examples, and as depicted in FIG. 2C, a third 222 user notification may be provided on the second device 112 indicating that the reconnection attempt with the first device 102 failed. In further examples, a retry option 216 may be provided that allows the user to select to retry the reconnection attempt. When the retry option 216 is selected on the second device 112, the calling application 114b may continue to operate in reconnect responder mode. For instance, the calling application 114b may continue to listen for the second call 108 from the first device 102 and handle other incoming calls 108 as defined.

In some examples, the third user notification 222 and/or retry option 216 may also be provided by the calling application 114a on the first device 102 when operating in reconnect initiator mode. When the retry option 216 is selected on the first device 102, the calling application 114a may continue to operate in reconnect initiator mode. For instance, the calling application 114a may reattempt to invite the second device 112 to join a communication session. In some examples, the calling application UI 134 may continue to provide the second user notification 212 to indicate the connection issue with the first device 102 and/or the reconnection attempt. The reconnection attempt may continue until the devices 102 and 112 are reconnected, the time-out threshold for reconnection attempts is reached, or a user option is selected to terminate the reconnection attempt.

Alternatively, in other implementations, the reconnect functionality may be implemented in the network 104 (e.g., included in or in communication with the call server 106). For instance, when the first call 108 is dropped and detected, the call server 106 may initiate an automated reconnection attempt to automatically reconnect a first device 102 and a second device 112 via a second call 108. In some examples, performing the reconnection attempt may cause the call server 106 to operate in “reconnect initiator mode” or in “reconnect responder mode”. The call server 106 may be configured to determine which mode (e.g., reconnect initiator mode or reconnect responder mode) to activate based on which device dropped the first call 108, which device initiated the first call 108, or another predetermined factor.

In some examples, the call server 106 retains context of the first call 108. Context of the first call 108 may include information about the call participants (e.g., phone numbers, IP addresses, and/or other unique resource identifiers of the devices 102 and 112), session parameters, media path details, etc. For instance, context of the first call 108 may be temporarily retained by the call server 106 and, in some examples, used to initiate, establish, or otherwise handle the second call 108 between the first device 102 and the second device 112. In some examples, one or more call setup steps of the second call 108 may be eliminated based on using the retained context of the first call 108. For instance, parameters such as codec selection, QoS settings, and/or other session-related configurations (e.g., encryption settings, network preferences, and/or user-specific settings) established during the first call 108 may be reused for the second call 108 and, thus, may avoid the need for the first device 102 and the second device 112 to renegotiate the parameters.

In examples, the call server 106 may maintain the first call 108 with the device that did not drop. For instance, when the call server 106 detects a drop of the first device 102 from the first call 108, the call server 106 may temporarily become an endpoint of the first call 108 with the second device 112. Thus, the second device 112 may continue to display a UI 134 of the calling application 114b. In some examples, the call server 106 may further signal the second device 112 of the drop of the first device 102 from the first call 108 and/or of the reconnection attempt. For instance, the second device 112 may provide a user notification (e.g., one or a combination of a visual alert, an audible, or a tactile alert) indicating a connection issue with the first device 102 and/or the reconnection attempt.

In some examples, when operating in reconnect initiator mode, the call server 106 may initiate the second call 108 by inviting the first device 102 to join a communication session. The call server 106 may temporarily become an endpoint of the second call 108. In other examples, the call server 106 may instruct (e.g., via a command or signal) the second device 112 to initiate the second call 108 with the first device 102. In yet other examples, the call server 106 may instruct the first device 102 to initiate the second call 108 with the second device 112 (e.g., after the first device 102 regains a connection to the network 104 and call server 106). In examples, one or more parameters may be applied to the second call 108, such as a time-out parameter for voicemail and/or reconnection attempts. For instance, the time-out parameter for voicemail may trigger a termination of the second call 108 to prevent the second call 108 from being forwarded to voicemail 116 if the second call 108 is not answered within a time-out threshold (e.g., after a certain number of rings or a specific duration). The time-out parameter for reconnection attempts may deactivate/end reconnect initiator mode if the second call 108 is not answered after a maximum number of reconnection attempts. In some examples, the calling application 114 operating on the first device 102 and/or the second device 112 may be configured to automatically answer the second call 108. In examples where the second call 108 is answered, the call server 106 may be further configured to merge the second call 108 with the first call 108.

In an example where the call server 106 operates in reconnect responder mode, the call server 106 may listen for the second call 108 from the first device 102 to the second device 112. When the second call 108 is received, the call server 106 may identify the second call 108 is a reconnection attempt based on the retained context of the first call 108 and then route the second call 108 to the second device 112. In some examples, the calling application 114 operating on the second device 112 may be configured to automatically answer the second call 108. In examples where the second call 108 is answered by the second device 112, the call server 106 may be further configured to merge the second call 108 with the first call 108.

According to an aspect, a determination as to whether a disconnected call 108 is intentionally ended or unintentionally dropped may be made by the calling application 114 or the call server 106. In some examples, a disconnected call 108 may be determined as an intentional disconnection when a user selection is received to end the call 108. For instance, user A may intentionally end the first call 108 by selecting an end call option (e.g., via a touch input, spoken command, gesture, or other user input), which may be detected by the first device 102 and which may trigger the calling application 114a to terminate the first call 108. In such cases, the calling application 114a may detect the user selection and determine the disconnection is intentional and as originating on the first device 102.

In some examples, the determination of an intentional disconnection may be communicated to the call server 106 and/or the other calling party. For instance, a first “bye” signal indicating that the first call 108 should be terminated may be sent by the first device 102 to the call server 106 and/or a second “bye” signal may be communicated to the second device 112 (e.g., by the first device 102 or the call server 106). In some examples, the second bye signal indicates to the call server 106 and/or second device 112 that the first call 108 was intentionally disconnected by the first device 102. For instance, the second bye signal may include a “do-not-reconnect” message. The do-not-reconnect message may indicate to the call server 106 and/or second device 112 to not initiate a reconnection attempt or to expect a second call 108 from the first device 102 in a reconnection attempt. Thus, in response to receiving the do-not-reconnect message, the call server 106 and/or calling application 114b operating on the second device 112 may not activate reconnect initiator or responder mode.

In some examples, a determination of whether a call disconnection may be an unintentional disconnection (e.g., a dropped call) is based on one or more factors. A first example factor may include whether a do-not-reconnect message is received. For instance, the calling application 114b on the second device 112 may a call 108 was dropped by the first device 102 when a do-not-reconnect message is not received within a threshold time period subsequent to the disconnection.

A second example factor may include connection status of the device 102 or 112 (e.g., connection with a cell tower, access point, or other network component). For instance, a low signal level (e.g., below a threshold) or an interrupted or lost signal when the disconnection occurs may indicate the corresponding device 102 or 112 may have dropped the call 108. Alternatively, a strong signal level (e.g., above the threshold) or an uninterrupted signal when the disconnection occurs may indicate the corresponding device 102 or 112 may not have dropped the call 108.

A third example factor may include location of the device 102 or 112 in relation to a defined call drop zone 110. In some examples, the call drop zone 110 may be defined manually by the user of the device 102 or 112 (e.g., in response to a user input). In other examples, the call drop zone 110 may be defined automatically by the calling application 114 or call server 106. A call drop zone 110 may be defined for a particular device 102 or 112 or, in some examples, may be applied to multiple devices 102 and 112. In examples, the call drop zone 110 may correspond to a location where previous calls 108 may have been dropped due to a loss of signal. For instance, the call drop zone 110 may correspond to a tunnel, parking garage, elevator, a location in a dense urban area, or other location where a number of previous calls 108 may have been dropped due to signal loss. The number of previously dropped calls 108 at the location may exceed a threshold, which may trigger the calling application 114 or the call server 106 to define the location as a call drop zone 110 and then store the call drop zone 110. As an example, when the first device 102 is near or in a defined call drop zone 110 when a disconnection occurs, the calling application 114a on the first device 102 or the call server 106 may determine the disconnection may be a dropped call 108 by the first device 102. As another example, when the second device 112 is not near or in a defined call drop zone 110 when a disconnection occurs (e.g., and a do-not-reconnect message is not received within a threshold time period after the disconnection), the calling application 114b on the second device 112 or the call server 106 may determine the first device 102 dropped the call 108. In other examples, the calling application may experience an issue that causes a call 108 to fail, which may be used as a factor to detect as an unintentional disconnection. Other example factors are contemplated.

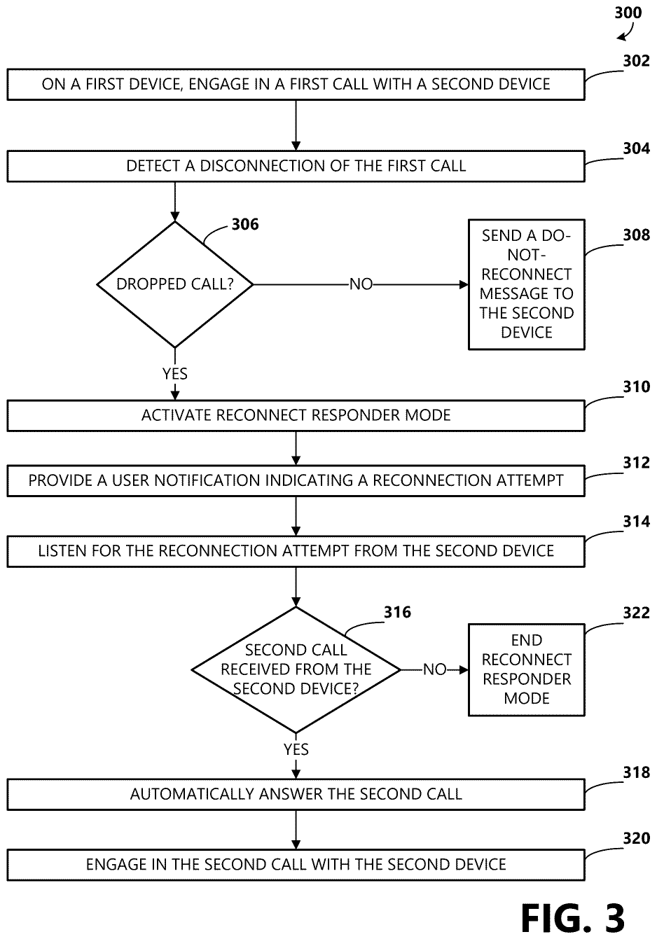

With reference now to FIG. 3, an example method 300 for providing automated dropped call reconnection is depicted. For instance, operations of method 300 correspond to steps performed by the calling application 114 to automatically reconnect a disconnected call 108 between a first device 102 and a second device 112. In some examples and as described in association with FIG. 3, the method 300 may be performed by the calling application 114a operating on the first device 102 when operating in reconnect responder mode. However, in other examples, the method 300 may be performed by the calling application 114b operating on the second device 112 in reconnect responder mode (e.g., and the calling application 114a operating on the first device 102 may operate in reconnect initiator mode).

At operation 302, the first device 102 may be engaged in a first call session (first call 108) with the second device 112 via a first communication link over a network 104 or combination of networks 104. The first call 108 may be one of various types of calls based on the devices 102 and 112 and network 104 implemented (e.g., a VoIP call, a VoLTE call, a PSTN call, or another type of call), where media (e.g., voice data) may be exchanged between the calling application 114a on the first device 102 and the calling application 114b on the second device 112.

At operation 304, a disconnection of the first call 108 may be detected. In some examples, the disconnection may be initiated by the first device 102. In other examples, the disconnection may be initiated by the second device 112. Detecting the disconnection may be based on receiving a request to disconnect (e.g., a user selection on the first device 102 or a request from the second device 112) or detecting a loss of communication (e.g., ceased or delayed signals exceeding a threshold) with the call server 106 and/or the second device 112.

At decision operation 306, a determination may be made as to whether the detected disconnection is an intentional disconnection (e.g., initiated by a user selection by a user of the first device 102 or the second device 112) or an unintentional dropped call (e.g., due to a failure on the device or in the first communication link between the devices). The determination may be based on one or a combination of factors.

In some examples, the determination may be based on whether a user input was received on the first device 102 corresponding to a user selection of an option to end the first call 108. For instance, if user A selects an end call option (e.g., via a touch input, spoken command, gesture, or other user input) on the first device 102, the first call 108 may be terminated and the disconnection may be determined as an intentional disconnection initiated by the first device 102. In other examples, the determination may be based on whether an indication of a user input was received on the second device 112 corresponding to a user selection of an option to end the first call 108. The indication of user B's selection may be a bye signal received from the second device 112. In some examples, the bye signal may be an indication of an intentional disconnection initiated by the second device 112. The by signal may include a do-not-reconnect message that indicates to the first device 102 to not perform a reconnection attempt with the second device 112.

In other examples, the determination of whether the disconnection is a dropped call may be based on the device's connection status with the network 104. For instance, a dropped call may be detected when the first device 102 experiences a signal level below a threshold, an interrupted signal, or a lost signal when the disconnection occurs.

In yet other examples, the determination of whether the disconnection is a dropped call may be based on whether the first device 102 is in or near a defined call drop zone 110. For instance, if the first call 108 is d is connected and the first device 102 is in the call drop zone 110, the disconnection may be determined as call dropped by the first device 102.

The determination of whether the disconnection is a dropped call may be further based on detection of an error experienced by the calling application 114a that causes the first call 108 to fail. The error may be detected by the calling application 114a or by the call server 106 and communicated to the calling application 114a. For instance, a detected occurrence of an error during the first call 108 may cause the calling application 114a to detect a dopped call. In other implementations, other factors may be used to make the determination.

In response to determining the disconnection is an intentional disconnection initiated by the first device 102, the method 300 may proceed to operation 308, where a signal (e.g., a bye signal) to terminate the first call 108 is sent to the second device 112. In some examples, the signal includes a do-not-reconnect message that indicates to the second device 112 that the first call 108 was intentionally ended. The do-not-reconnect message may cause the second device 112 to disconnect from the first call 108 and to not initiate a reconnection attempt with the first device 102.

In response to determining the disconnection is a dropped call, the method 300 may proceed to operation 310, where reconnect responder mode may be activated. In some examples, when operating in reconnect responder mode, the calling application 114a may keep state of the first call 108 on the first device 102 by keeping the UI 134 of the calling application 114a open and active. Additionally, context of the first call 108 may be retained by the calling application 114a, such as information about the other call participant (e.g., phone number, IP address, and/or other unique resource identifier of the second device 112), session parameters, media path details, etc.

At operation 312, a user notification (e.g., the first user notification 202 or the second user notification 212) may be provided via one or a combination of a visual alert, an audible, or a tactile alert that informs user A of a connection issue with the second device 112 and/or a reconnection attempt. In some examples, the user notification may indicate to user A to hold and not close the calling application 114a. In some examples, a cancel option 206 may be provided to cancel the reconnection attempt, which when selected by user A, deactivates or ends reconnect responder mode. In further examples, a do-not-reconnect message may be sent to the second device 112 to cancel the reconnection attempt.

At operation 314, when operating in reconnect responder mode, incoming calls 108 may be monitored for the reconnection attempt from the second device 112. For instance, when an incoming call 108 is detected, a unique identifier of the calling device (e.g., a phone number, IP address, or SIP address) may be compared to the retained context of the first call 108 to determine whether the incoming call 108 is from the second device 112. A determination may be made at decision operation 316 as to whether the calling device of the incoming call 108 matches the retained context of the first call 108.

When the calling device of the incoming call 108 is determined to be the second device 112, the method 300 may proceed to operation 318, where the second call 108 is automatically answered. In some examples, the calling application 114a may not announce the incoming second call 108 and may automatically connect to the second device 112. Signals may be exchanged between the calling application 114a of the first device 102 and the calling application 114b of the second device 112 via the call server 106 to re-establish a second communication link over the network 104. In some examples, the second call 108 may be merged with the first call 108. At operation 320, the first device 102 and the second device 112 may be re-engaged in communication via the second call 108. In examples, the UI 134 of the calling application 114a on the first device 102 may be updated to indicate that an active call 108 with the second device 112 is in progress. Thus, a seamless interface for user A may be provided that may minimize the negative impact of the disconnection.

When the calling device of the incoming call 108 is determined to not be the second device 112 at decision operation 316, the calling application 114a may continue to listen for the second call 108 from the second device 112 and manage the incoming call 108 based on a call handling configuration. For instance, the calling application 114a may be configured to not answer the incoming call 108, where the incoming call 108 may be ignored, forwarded to voicemail 116, or handled using a call waiting feature or other call management option.

In some examples, after a timeout threshold has passed without receiving the second call 108 from the second device 112, a determination may be made at operation 322 to deactivate/end reconnect responder mode. In some examples, a user notification (e.g., the third user notification 222) may be provided on the first device 102 indicating that the reconnection attempt failed. In further examples, a retry option 216 may be provided that allows user A to select to retry the reconnection attempt with the second device 112. When the retry option 216 is selected, the method 300 may return to operation 312 or, in some examples, the calling application 114a may activate reconnect initiator mode in a reconnection attempt with the second device 112.

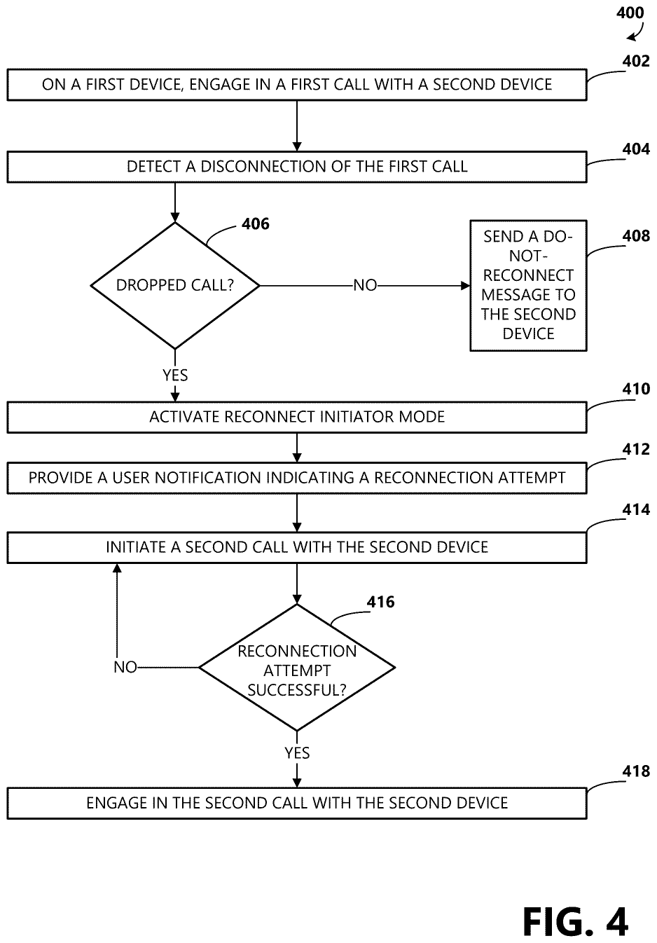

An example method is depicted in FIG. 4 including steps performed by the calling application 114 when operating in reconnect initiator mode to automatically reconnect a dropped call. In some examples, and as described in FIG. 4, method 400 may be performed by the calling application 114a operating on a first device 102 when operating in reconnect initiator mode to reconnect a dropped call 108 with a second device 112 that may be operating in reconnect responder mode. In other examples, method 400 may be performed by the calling application 114b operating on the second device 112 when operating in reconnect initiator mode to reconnect a disconnected call 108 with the first device 102 that is operating in reconnect responder mode. With reference now to FIG. 4, at operation 402, the first device 102 may be engaged in a first call session (first call 108) with the second device 112 via a first communication link over a network 104 or combination of networks 104. The first call 108 may be one of various types of calls based on the devices 102 and 112 and network 104 implemented (e.g., a VoIP call, a VoLTE call, a PSTN call, or another type of call), where media (e.g., voice data) may be exchanged between the calling application 114a on the first device 102 and the calling application 114b on the second device 112

At operation 404, a disconnection of the first call 108 may be detected. In some examples, the disconnection may be initiated by the first device 102. In other examples, the disconnection may be initiated by the second device 112. Detecting the disconnection may be based on receiving a request to disconnect (e.g., a user selection on the first device 102 or a request from the second device 112) or detecting a loss of communication (e.g., ceased or delayed signals exceeding a threshold) with the call server 106 and/or the second device 112.

At decision operation 406, a determination may be made as to whether the detected disconnection is an intentional disconnection (e.g., initiated by a user selection by a user of the first device 102 or the second device 112 to end the first call 108) or a dropped call (e.g., due to a failure on the device or in the first communication link between the devices). The determination may be based on one or a combination of factors (as described above in association with FIG. 3).

In some examples, in response to determining the disconnection is an intentional disconnection initiated by the first device, the method 400 may proceed to operation 408, where a signal (e.g., a bye signal) to disconnect from the first call 108 is sent to the second device 112. In some examples, the signal includes a “do-not-reconnect” message that indicates to the second device 112 that the first call 108 was intentionally disconnected and to not activate reconnect responder mode.

Alternatively, the disconnection may be determined to be a dropped call based on one or a combination of factors. In some examples, the first call 108 is dropped by the second device 112 and a signal or message indicating the unintentional disconnection may be provided to the first device 102 from the call server 106 or the second device 112. In other examples, the dropped call 108 may be detected based on not receiving a signal from the second device 112 that indicates an intentional disconnection, such as the “do-not-reconnect” message. In some examples, a call dropped by the first device 102 may be detected based on the first device's connection status with the network 104 and/or whether the first device 102 is in or near a defined call drop zone 110. In other examples, the calling application 114a may experience an issue that causes the first call 108 to fail, which may be determined as a dropped call. Other example factors are contemplated.

In response to determining the disconnection is a dropped call, the method 400 may proceed to operation 410, where reconnect initiator mode may be activated. When operating in reconnect initiator mode, the calling application 114a may keep state of the first call 108 on the first device 102 by 102 by keeping the UI 134 of the calling application 114a open and active. Additionally, context of the first call 108 may be retained by the calling application, such as information about the other call participant (e.g., phone number, IP address, and/or other unique resource identifier of the second device 112), session parameters, media path details, etc.

At operation 412, a user notification (e.g., the first user notification 202 or the second user notification 212) may be provided that informs user A of a connection issue and/or a reconnection attempt with the second device 112. The user notification may include one or a combination of a visual alert, an audible, or a tactile alert. In some examples, a cancel option 206 is provided to cancel the reconnection attempt, which when selected by user A, deactivates or ends reconnect initiator mode. In further examples, a do-not-reconnect message may be sent to the second device 112 to cancel the reconnect responder mode on the second device 112.

At operation 414, a second call 108 may be initiated with the second device 112. In some examples, the calling application 114b may use the context of the first call 108 to initiate the second call 108 with the second device 112. In some examples, initiating the second call 108 may include applying one or more parameters to the second call 108, such as a time-out parameter for voicemail. For instance, the time-out parameter may terminate the second call attempt to prevent the second call 108 from being forwarded to voicemail 116 if the call is not answered by the second device 112 when a time-out threshold is met.

At decision operation 416, a determination may be made as to whether the reconnection attempt with the second device 112 is successful. For instance, the calling application 114a may determine whether the second call 108 was accepted/answered by the second device 112. If the second call 108 was not answered by the second device 112, the reconnection attempt may be retried at operation 414. In some examples, another parameter that may be applied to the second call 108 includes a time-out parameter for connection attempts. For instance, the time-out parameter may deactivate/end reconnect initiator mode if the second call 108 is not answered after the maximum number of reconnection attempts. In some examples, a user notification (e.g., the third user notification 222) may be provided on the first device 102 indicating that the reconnection attempt failed. In further examples, a retry option 216 may be provided that allows user A to select to retry the reconnection attempt with the second device 112. When the retry option 216 is selected, the method 400 may return to operation 414.

Alternatively, when the second call 108 is accepted/answered by the second device 112, the method 400 proceeds from decision operation 416 to operation 418, where signals may be exchanged between the calling application 114a of the first device 102 and the calling application 114b of the second device 112 to re-establish a second communication link over the network 104. Accordingly, the first device 102 and the second device 112 may be re-engaged in communication via the second call 108. In some examples, the second call 108 may be merged with the first call 108 and the UI 134 of the calling application 114a of the first device 102 may be updated to indicate that an active call 108 with the second device 112 is in progress. Thus, a seamless interface for user A may be provided that may minimize the negative impact of the disconnection.

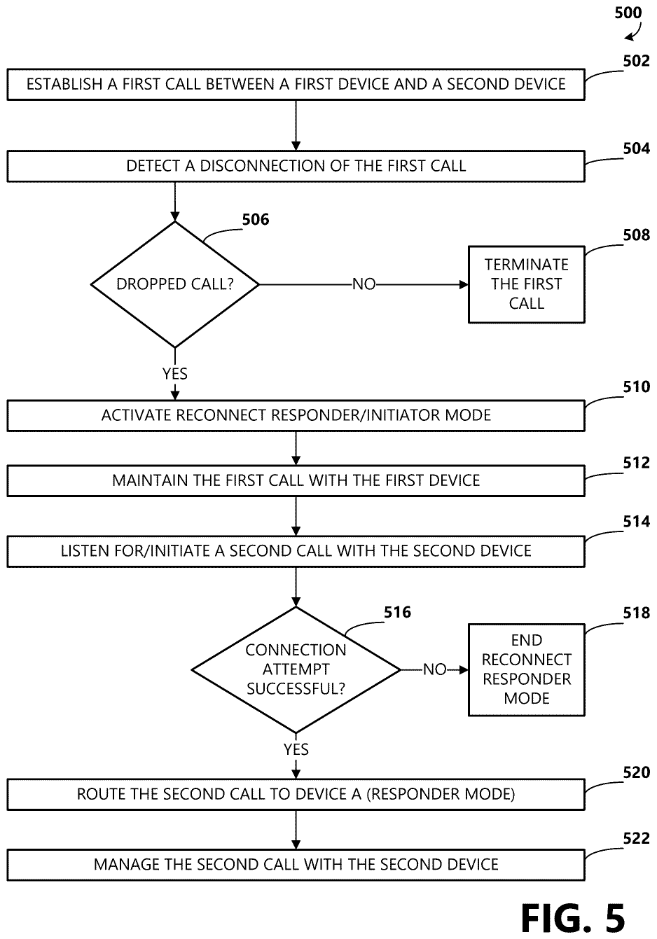

FIG. 5 depicts a method 500 for providing automated dropped call reconnection according to another example. For instance, operations of method 500 may be performed by a call server 106 when a call 108 is disconnected between the first device 102 and the second device 112. The call server 106 may be implemented in the network 104 as an SIP server, a PBX, a communication server, an application server, or another type of network component responsible for managing signaling and routing of calls 108 in the network 104.

In some implementations, the system 100 may include a first call server 106a implemented to manage how calls 108 are handled and connected to the first device 102 and a second call server 106b implemented to manage how calls 108 are handled and connected to the second device 112. The first call server 106a and the second call server 106b may communicate with each other to establish and manage calls 108 between the first device 102 and the second device 112. In such implementations, operations described in reference to the call server 106 may represent operations performed by the first call server 106a. Further communications to the second device 112 may be communicated via the second call server 106b.

At operation 502, a first call 108 may be established between the calling application 114a on the first device 102 and the calling application 114b on the second device 112 via a first communication link over a network 104 or combination of networks (e.g., a cellular network, an IP network, a VoLTE network, and/or a traditional landline). For instance, the call server 106 may perform tasks such as call routing, session initiation, and maintaining call state of the first call 108. In some examples, the first call 108 is initiated by the first device 102. In other examples, the first call 108 may be initiated by the second device 112. In yet other examples, the first call 108 may be initiated by the call server 106.

At operation 504, a disconnection of the first call 108 is detected. In some examples, the disconnection may be initiated by the first device 102. In other examples, the disconnection may be initiated by the second device 112. Detecting the disconnection may be based on receiving a request to disconnect (e.g., a user selection on the first device 102 or a request from the second device 112) or detecting a loss of communication (e.g., ceased or delayed signals exceeding a threshold) with the first device 102 or the second device 112.

At decision operation 506, a determination may be made as to whether the disconnection was intentionally ended by a user of the first device 102 or second device 112 or whether the first call 108 was dropped. In some examples, the determination is based on whether an indication of a user selection of an option to end the first call 108 (e.g., initiated by user A of the first device 102 or initiated by user B of the second device 112) is received. In other examples, the determination may be based on whether a request (or signal) to disconnect from the first call 108 is received (e.g., a bye signal). In further examples, the determination may be based on whether a do-not-reconnect message is sent. For instance, the do-not-reconnect message may be sent from one device to the other via the call server 106. In other examples, the determination of a dropped call may be based on the first device's and/or the second device's connection status with the network 104 and/or the call server 106. For instance, the call server 106 may check the signal strength and/or other quality metrics from one or both devices 102 and/or 112 to assess whether the disconnection may be due to poor connectivity. In other examples, the determination may be based on whether one the devices 102 or 112 is in or near a defined call drop zone 110. In other examples, the determination may be based on whether an issue experienced by the first device 102 or the second device 112 that caused the first call 108 to fail is detected. Other example factors may be used to make the determination.

In some examples, in response to determining the disconnection is an intentional disconnection, the method 500 may proceed to operation 508, where the first call 108 may be terminated. For instance, resources reserved or allocated for the first call 108 may be released for other uses and a signal to disconnect from the first call 108 may be sent to the first 102 and/or second device 112. In some examples, the signal includes the do-not-reconnect message that indicates the disconnection was intentionally.

In response to determining the disconnection is a dropped call, the method 500 may proceed to operation 510, where context of the first call 108 may be retained, e.g., by the call server 106. For instance, context may include information about the first device 102 and second device 112 (e.g., phone number, IP address, and/or other unique resource identifier), session parameters, media path details, and/or other information about the first call 108.

In some examples, at operation 512, the first call 108 with the second device 112 may be maintained. For instance, when the call server 106 detects a drop of the first device 102 from the first call 108, the call server 106 may temporarily become an endpoint for the first call 108 with the second device 112. In examples, the second device 112 may continue to display a UI 134 of the calling application 114b. In some examples, the call server 106 may further signal the second device 112 of the drop of the first device 102 from the first call 108 and/or of the reconnection attempt. In response, the second device 112 may provide a user notification (e.g., one or a combination of a visual alert, an audible, or a tactile alert) indicating the connection issue with the first device 102 and/or the reconnection attempt.

In some examples, a cancel option 206 is provided to cancel the reconnection attempt, which when selected, may be communicated to the call server 106. The call server 106 may deactivate or end reconnect initiator or responder mode and release the context of the first call 108.

At operation 514, the second call 108 may be initiated (when operating in reconnect initiator mode). For instance, the call server 106 may temporarily become an endpoint for the second call 108. Or, when operating in reconnect responder mode, incoming calls 108 may be monitored for the second call 108 from the first device 102 or the second device 112. When operating in reconnect initiator mode, the context of the first call 108 may be used to initiate the second call 108. In some examples, one or more call setup steps may be eliminated based on using the retained context of the first call 108. In some examples, initiating the second call 108 includes applying one or more parameters to the second call 108, such as a time-out parameter for voicemail. For instance, the time-out parameter may terminate the second call attempt to prevent the second call 108 from being forwarded to voicemail 116 if the call is not answered. When operating in reconnect responder mode and an incoming call 108 is detected, a unique identifier of the calling device (e.g., a phone number, IP address, or SIP address) may be compared to the retained context of the first call 108 to determine whether the incoming call 108 is from the first device 102 or second device 112.

A determination may be made at decision operation 516 as to whether the reconnection attempt with the second device 112 is successful. When operating in reconnect initiator mode, the determination may be based on whether the second call 108 was accepted/answered by the second device 112. If the second call 108 was not answered by the second device 112, the reconnection attempt may be retried at operation 514. In some examples, another parameter that may be applied to the second call 108 includes a time-out parameter for retry attempts. For instance, the time-out parameter may deactivate/end reconnect initiator mode if the second call 108 is not answered after the maximum number of reconnection attempts. In some examples, a user notification (e.g., the third user notification 222) may be provided to the first device 102 and/or the second device 112 indicating that the reconnection attempt failed. In further examples, a retry option 216 may be provided that allows the user to select to retry the reconnection attempt with the other device. When an indication the retry option 216 is selected is received, the method 500 may return to operation 514. Alternatively, when a determination is made that the second call 108 is accepted/answered by the called device at decision operation 516, the method 500 proceeds to operation 522, where signals may be exchanged between the call server 106 and the first device 102 and the second device 112 to re-establish a second communication link over the network 104. Accordingly, the first device 102 and the second device 112 may be re-engaged in communication via the second call 108.

When operating in reconnect responder mode, the determination at decision operation 516 as to whether the reconnection attempt is successful may be based on whether information about the calling device of the incoming call 108 matches the retained context of the first call 108. When the incoming call information does not match the retained context of the first call 108, the incoming call 108 may be managed based on a call handling configuration. For instance, the call server 106 may be configured to ignore the incoming call 108, forward the incoming call 108 to voicemail 116, or handle the incoming call 108 using a call waiting feature or other call management option. When the calling device of the incoming call 108 is determined to be from the first device 102 or the second device 112, the method 500 may proceed to operation 520, where the second call 108 is routed to the called device (e.g., the first device 102 or the second device 112). In examples, the second call 108 may be automatically answered by the calling application 114 of the called device.

At operation 522, signals may be exchanged between the call server 106 and the first device 102 and the second device 112 to re-establish a second communication link over the network 104. In examples, the call server 106 may merge the second call 108 with the first call 108, and the first device 102 and the second device 112 may be re-engaged in communication. Additionally, the user interface of the first device 102 and the second device 112 may be updated to indicate that an active call 108 with the second device 112 is in progress.

Alternatively, after a timeout period has passed without receiving the second call 108 from the first device 102 or the second device 112, a determination may be made at operation 518 to deactivate/end reconnect responder mode. In some examples, a user notification (e.g., the third user notification 222) may be provided to the first device 102 and/or second device 112 indicating that the reconnection attempt failed.

FIG. 6 is a system diagram of a computing device 600 according to an example. The computing device 600, or various components and systems of the computing device 600, may be integrated or associated with one or more components of system 100. As shown in FIG. 6, the physical components (e.g., hardware) of the computing device 600 are illustrated and these physical components may be used to practice the various aspects of the present disclosure.

The computing device 600 may include at least one processing unit 610 and a system memory 620. The system memory 620 may include, but is not limited to, volatile storage (e.g., random access memory), non-volatile storage (e.g., read-only memory), flash memory, or any combination of such memories. The system memory 620 may also include an operating system 630 that controls the operation of the computing device 600 and one or more program modules 640. The program modules 640 may be responsible for performing one more of the operations of the methods 300, 400, and/or 500 described above for providing automated dropped call reconnection. A number of different program modules and data files may be stored in the system memory 620. While executing on the processing unit 610, the program modules 640 may perform the various processes described above. One example program module 640 includes the calling application 114. Another example program module 640 includes the call server 106.

The computing device 600 may also have additional features or functionality. For example, the computing device 600 may include additional data storage devices (e.g., removable and/or non-removable storage devices) such as, for example, magnetic disks, optical disks, or tape. These additional storage devices are labeled as a removable storage 660 and a non-removable storage 670.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 600 on the single integrated circuit (chip). The disclosure may also be practiced using other technologies capable of performing logical operations such as, for example, AND, OR, and NOT, including but not limited to mechanical, optical, fluidic, and quantum technologies.

The computing device 600 may include one or more communication systems 680 that enable the computing device 600 to communicate with other computing devices 695 such as, for example, routing engines, gateways, signings systems and the like. Examples of communication systems 680 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 600 may also have one or more input devices and/or one or more output devices shown as input/output devices 690. These input/output devices 690 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 620, the removable storage 660, and the non-removable storage 670 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, performed by a first device, comprising:
engaging in a first call with a second device including causing a user interface for the first call to be displayed;
maintaining, after detecting a drop of the first call, the user interface for the first call;
activating one of a reconnect initiator mode or a reconnect responder mode;
when operating in the reconnect initiator mode:
initiating a second call with the second device; and
engaging in the second call with the second device when the second call is answered by the second device; and
when operating in the reconnect responder mode:
listening for the second call from the second device;
automatically answering the second call when the second call from the second device is received; and
engaging in the second call with the second device.

2. The method of claim 1, further comprising:
retaining context of the first call; and
when operating in the reconnect initiator mode, using the retained context to initiate the second call.

3. The method of claim 1, further comprising:
retaining context of the first call; and
when operating in the reconnect responder mode:
comparing the retained context to context of the second call; and
automatically answering the second call when the retained context matches the context of the second call.

4. The method of claim 1, wherein automatically answering the second call comprises not alerting a user of the first device when the second call from the second device is received.

5. The method of claim 1, wherein detecting the drop of the first call comprises determining a user selection to end the first call is not received within a threshold time period.

6. The method of claim 1, wherein detecting the drop of the first call comprises determining a do-not-reconnect message, associated with a user selection on the second device to end the first call, is not received within a threshold time period.

7. The method of claim 1, wherein detecting the drop of the first call comprises detecting an interruption in connection status between the first device and a network.

8. The method of claim 1, wherein detecting the drop of the first call comprises determining the first device is in a defined call drop zone.

9. The method of claim 1, further comprising:
detecting a location of the first device in relation to the drop of the first call;
determining, after the drop of the first call, a threshold number of dropped calls related to the location is satisfied;
defining the location as a call drop zone; and
storing the call drop zone.

10. The method of claim 9, further comprising sending the call drop zone to a call server.

11. The method of claim 1, wherein initiating the second call comprises applying a time-out parameter to the second call to prevent the second call from being forwarded to voicemail when the second call is not answered by the second device within a threshold.

12. The method of claim 1, wherein initiating the second call comprises applying a time-out parameter to the second call to end the reconnection attempt when the second call is not answered by the second device within a threshold number of attempts.

13. The method of claim 1, wherein maintaining the user interface of the first call comprises providing a user notification indicating the drop of the first call.

14. The method of claim 1, wherein maintaining the user interface of the first call comprises providing a user notification indicating the reconnection attempt.

15. A system of a first device comprising:
at least one processing unit; and
memory storing instructions that, when executed by the at least one processing unit, cause the system to perform operations comprising:
engaging in a first call with a second device including causing a user interface for the first call to be displayed;
maintaining, after detecting a drop of the first call, the user interface for the first call;
activating one of a reconnect initiator mode or a reconnect responder mode;
when operating in the reconnect initiator mode:
initiating a second call with the second device; and
engaging in the second call with the second device when the second call is answered by the second device; or
when operating in the reconnect responder mode:
listening for the second call from the second device;
automatically answering the second call when the second call from the second device is received; and
engaging in the second call with the second device.

16. The system of claim 15, wherein detecting the drop of the first call comprises at least one of:
determining a user selection to end the first call is not received;
determining a do-not-reconnect message, associated with a user selection on the second device to end the first call, is not received;
detecting an interruption in connection status between the first device and a network; or
determining the first device is in a defined call drop zone.

17. The system of claim 15, the operations further comprising:
detecting a location of the first device in relation to the drop of the first call;
determining, after the drop of the first call, a threshold number of dropped calls related to the location is satisfied;
defining the location as a call drop zone; and
storing the call drop zone.

18. A method, performed by a call server, comprising:
detecting a drop of a first device from a first call facilitated by the call server between the first device and a second device;
activating one of a reconnect initiator mode or a reconnect responder mode;
when operating in the reconnect initiator mode:
maintaining the first call with the second device by becoming a temporary endpoint of the first call;
initiating a second call from the call server to the first device; and
merging the first call with the second call when the second call is answered by the first device; or
when operating in the reconnect responder mode:
maintaining the first call with the second device;
listening for the second call from the first device;
routing the second call to the second device when the second call from the second device is received; and
merging the first call with the second call when the second call is answered by the second device.

19. The method of claim 18, further comprising signaling to the second device of at least one of:
the drop of the first device from the first call; or
the reconnection attempt.

20. The method of claim 18, wherein detecting the drop of the first device from the first call comprises at least one of:
determining a user selection to end the first call is not received;
determining a do-not-reconnect message, associated with a user selection on the second device to end the first call, is not received;
detecting an interruption in connection status between the first device and a network; or
determining the first device is in a defined call drop zone.
